(19) United States
(12) Patent Application Publication
(10) Pub. No.: US 2005/0027644 A1
(43) Pub. Date: Feb. 3, 2005

(54) Commoditized bandwidth trading system and method

(76) Inventor: Kayato Sekiya, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/901,208

(22) Filed: Jul. 29, 2004

(30) Foreign Application Priority Data
Jul. 29, 2003 (JP) 2003-281831

(51) Int. Cl. G06F 17/60

(52) U.S. Cl. 705/37

(57) ABSTRACT

A commoditized bandwidth trading system comprises a seller's terminal, a buyer's terminal and a trading point. The seller's terminal transmits a seller's order indicating a plurality of bandwidth contract terms, at least one of the bandwidth contract terms containing a selectable range of characteristics, a trading point for receiving the seller's order and advertising the plurality of bandwidth contract terms of the received seller's order. The buyer's terminal transmits a buyer's response to the trading point in response to the advertised seller's order. If the trading point verifies the buyer's response, the buyer's terminal selects one of the characteristics of the advertised seller's order, and transmits a connection request indicating bandwidth contract terms. At least one of the contract terms contains the selected characteristic. According to the contract terms of the connection request, a bandwidth segment is connected at connecting points to a buyer's network.

### BACKGROUND OF THE INVENTION

1. Field of the Invention

The present invention relates to a system and method for trading commoditized bandwidth.

2. Description of the Related Art

The trading of commoditized bandwidth is known. As disclosed in U.S. patent application Publication No. 2002/0004788 A1 (Jan. 10, 2002), bandwidth is pooled between first and second pooling points in a communication system and commoditized by making available tradable bandwidth segments having negotiable sizes and determinable characteristics. A transaction is initiated between a seller and a buyer for at least one bandwidth segment to deliver bandwidth from the seller to the buyer. The delivered bandwidth is monitored to ensure that the bandwidth is delivered according to agreed upon terms. The agreed upon terms include capacity, connecting points, period of use, type of interface (protocol) and quality of service.

In the prior art trading system, however, the traded bandwidth is provisioned strictly according to the agreed upon terms. If there is a significant time-lapse from the time a contract is concluded for a scheduled plan, it can occur that the commodity is not utilized for the full period of use or the user cannot change the contracted connecting points as desired within a permissible range if the scheduled plan is altered or cancelled. In such a case, the bandwidth as a commodity loses its value. Hence the storability and mobility of the prior art commoditized bandwidth are significantly low.

If the storability and mobility of commoditized bandwidth are enhanced, terms of contract for a bandwidth commodity can be easily and smoothly concluded and transactions and negotiations between sellers and buyers can be simplified.

### SUMMARY OF THE INVENTION

It is therefore an object of the present invention to provide a system and a method for enhancing the storability and the mobility of commoditized bandwidth.

Another object of the present invention is to facilitate the trading of commoditized bandwidth by giving flexibility to transactions between sellers and buyers.

According to a first aspect of the present invention, there is provided a commoditized bandwidth trading system comprising a seller's terminal, a buyer's terminal and a trading point. The seller's terminal transmits a seller's order indicating a plurality of bandwidth contract terms, at least one of the bandwidth contract terms containing a selectable range of characteristics. The trading point receives the seller's order and advertises the bandwidth contract terms of the received seller's order and determines whether or not a buyer's response, which will be received in response to the advertised seller's order, is verified. The buyer's terminal transmits the buyer's response to the trading point in response to the advertised seller's order, selects one of the characteristics of the advertised seller's order if the buyer's response is verified by the trading point, and transmits a connection request indicating a plurality of bandwidth contract terms, at least one of the bandwidth contract terms containing the selected characteristic. Connecting means is provided for receiving the connection request from the buyer's terminal and connecting a bandwidth segment to a buyer's network according to the bandwidth contract terms indicated in the received connection request.

According to a second aspect, the present invention provides a method of trading a commoditized bandwidth, comprising the steps of (a) transmitting a seller's order indicating a plurality of bandwidth contract terms from a seller's terminal to a trading point, at least one of the bandwidth contract terms containing a selectable range of characteristics, (b) receiving the seller's order at the trading point and advertising the bandwidth contract terms of the received seller's order, (c) transmitting a buyer's response from a buyer's terminal to the trading point corresponding to the advertised seller's order, (d) selecting one of the characteristics of the advertised seller's order at the buyer's terminal when the buyer's response is verified by the trading point, and transmitting a connection request indicating a plurality of bandwidth contract terms, at least one of the bandwidth contract terms containing the selected characteristic, and (e) responsive to the connection request from the buyer's terminal, connecting a bandwidth segment to a buyer's network according to the bandwidth contract terms indicated in the connection request.

According to a third aspect, the present invention provides a method of trading a commoditized bandwidth, comprising the steps of (a) transmitting a seller's auction order indicating a plurality of bandwidth contract terms from a seller's terminal to a trading point, at least one of the bandwidth contract terms containing a selectable range of characteristics, (b) receiving the seller's order at the trading point and advertising the bandwidth contract terms of the received seller's auction order, (c) transmitting a buyer's bidding order from a buyer's terminal to the trading point in response to the advertised seller's order, (d) determining, at the trading point, whether or not the buyer's bidding order is verified, and advertising the buyer's bidding order if the buyer's bidding order is verified, (e) repeating the steps (b) to (d) so that a plurality of verified buyer's bidding orders are advertised, (f) choosing, at the seller's terminal, one of the buyer's terminals whose advertised bid is highest of all advertised buyer's bidding orders, (g) selecting one of the characteristics of the advertised seller's order at the chosen buyer's terminal and transmitting a connection request indicating a plurality of bandwidth contract terms, at least one of the bandwidth contract terms containing the selected characteristic, and (h) responsive to the connection request from the chosen buyer's terminal, connecting a bandwidth segment to a buyer's network according to the bandwidth contract terms indicated in the connection request.

### BRIEF DESCRIPTION OF THE DRAWINGS

The present invention will be described in detail further with reference to the following drawings, in which:

FIG. 1 is a block diagram of a communications system in which a bandwidth trading system is incorporated according to the present invention;

FIG. 2 is an illustration of the data structure of a request packet transmitted to a trading point system from either a seller's computer terminal or a buyer's computer terminal;

FIG. 3 is a flowchart of the operation of the processor of FIG. 1 in response to a request packet containing a seller's order;

FIG. 4 is an illustration of the electronic bulletin board of FIG. 1 when a list of commoditized bandwidth segments is advertised;

FIG. 5 is a flowchart of the operation of the buyer's computer terminal according to a first embodiment of the present invention in which selectable items or values of contract are selected by the user within the range of contract before a connection request is transmitted to the trading point system;

FIG. 6 is an illustration of a connection request transmitted from the buyer's computer terminal to the trading point system;

FIG. 7 is a flowchart of the operation of the trading point processor according to the first embodiment in response to the connection request from the buyer;

FIG. 8 is a flowchart of the operation of the trading point processor according to a second embodiment of the present invention in which transactions proceed between a seller and a plurality of buyers in an auction mode;

FIG. 9 is an illustration of the bulletin board when commoditized bandwidth segments are auctioned;

FIG. 10 is a flowchart of the operation of the processor according to a third embodiment of the present invention in which a bandwidth segment once traded to a buyer is put on resale by the buyer;

FIG. 11 is a block diagram of the communications system according to a modified embodiment of the present invention in which traded bandwidth is monitored for transmitting a notification message to both seller and buyer when the bandwidth quality becomes lower than a specified level; and

FIG. 12 is a flowchart of the operation of the processor of FIG. 11.

### DETAILED DESCRIPTION

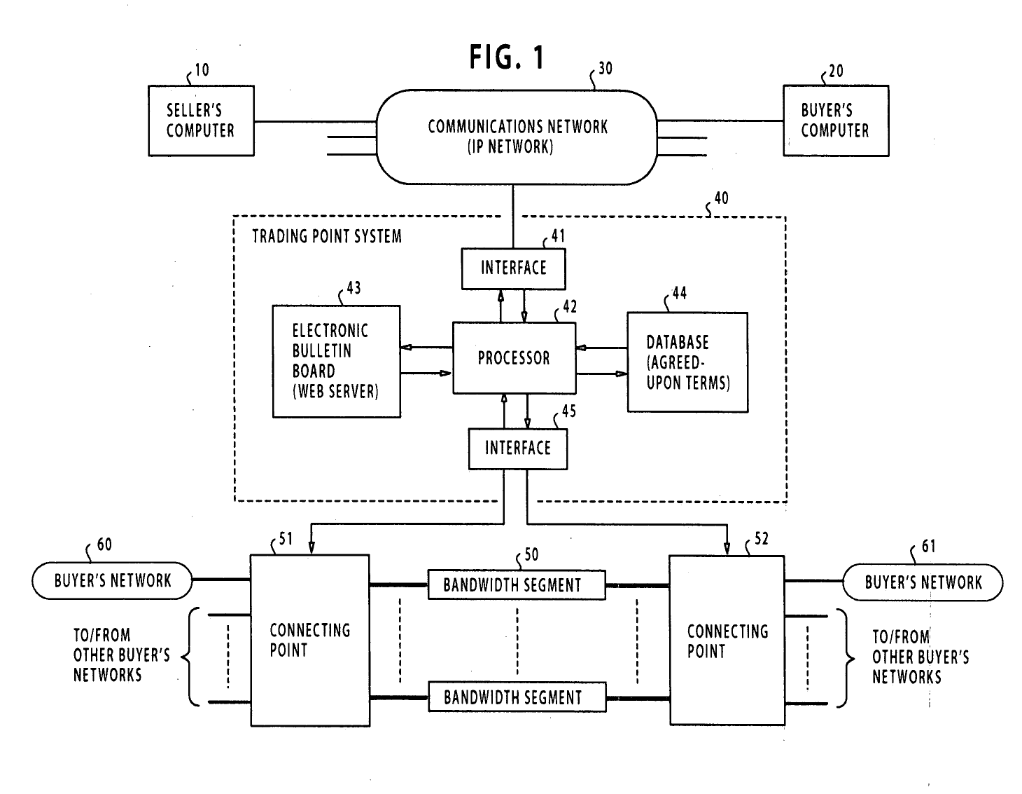

Referring now to FIG. 1, a communications system incorporating the present invention is illustrated. The communications system comprises at least one seller's computer terminal 10 and at least one buyer's computer terminal 20. Both computer terminals are connected via a communications network 30 such as IP network to a trading point system 40.

Trading point system 40 includes a processor 42, which is connected through a line interface 41 to the IP network 30 to establish communication with the seller's terminal 10 and the buyer's terminal 20. Processor 42 is connected to an electronic bulletin board 43 such as Web server and a database 44 for updating their contents in response to a request packet from the seller's or buyer's terminal. Processor 42 is further connected via a line interface 45 to connecting points 51 and 52 of the seller. A plurality of seller's tradable bandwidth segments 50 are connected between the connecting points 51 and 52. A plurality of buyer's networks are connected to both connecting points 51 and 52. As an exemplary embodiment, a buyer's first network 60 is connected to the first connecting point 51 and a buyer's second network 61 is connected to the second connecting point 52.

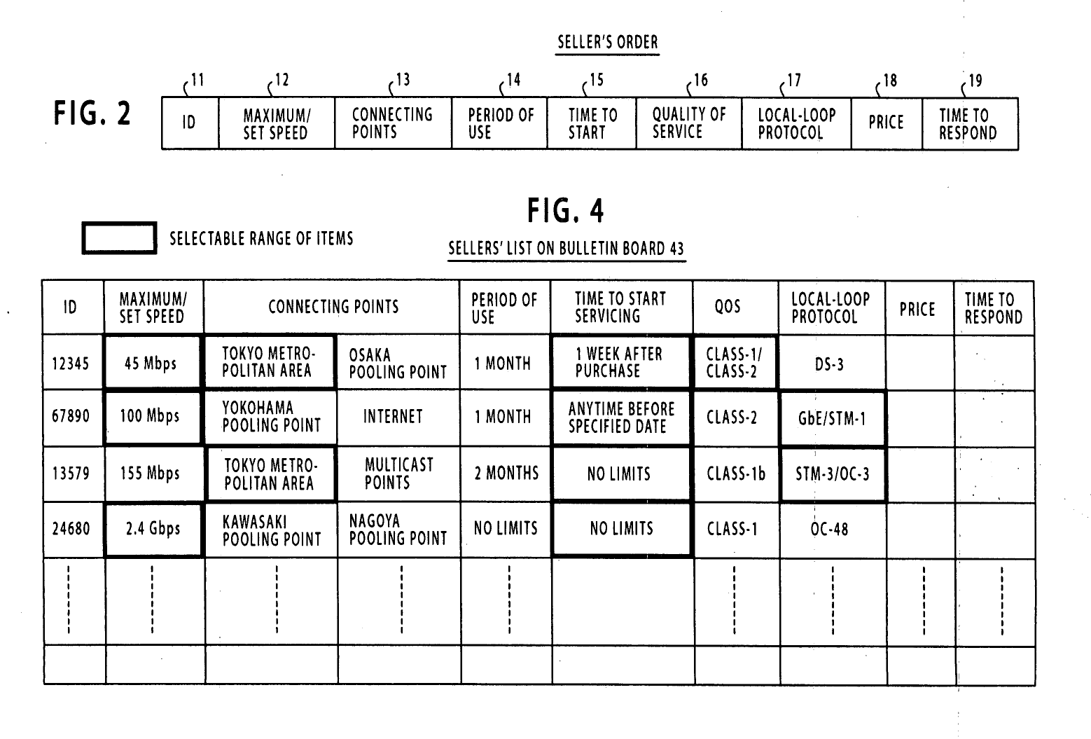

Seller's computer terminal 10 transmits a request packet to the trading point system 40 when the seller desires to place an order for selling at least one bandwidth segment as a tradable commodity. As shown in FIG. 2, the request packet contains a plurality of fields 11 through 19 in which the seller specifies desired values for the tradable bandwidth segment. Field 11 contains the identification number of a commoditized tradable bandwidth of a seller. The seller specifies a maximum or a seller-specified transmission speed for a commoditized tradable bandwidth segment in the maximum/specified speed field 12, and connecting points of the bandwidth segment in the connecting points field 13. A period of use is specified in the fourth field 14 and a time-to-start using the commodity is specified in the fifth field 15. The time-to-start using may be the first day within the contracted period of use. A quality of service (class) is specified in the field 16 and a local-loop protocol is specified in the field 17. The price of the bandwidth segment is given in the field 18. Further, the seller specifies, in the field 19, a time limit in which to receive a reply packet from a buyer, indicating a list of items corresponding to those of the seller's order.

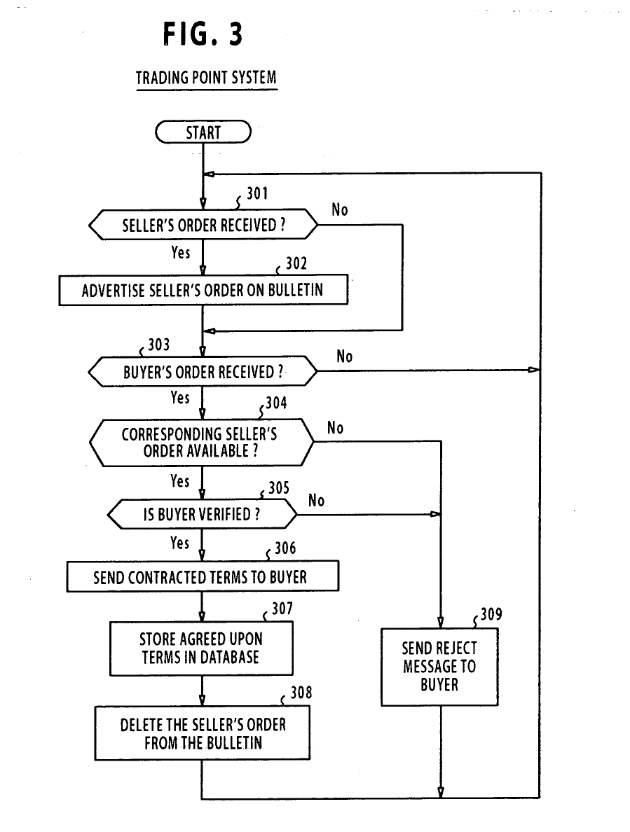

FIG. 3 is a flowchart of the operation of the trading point processor 42 when a seller transmits an order to the trading point 40.

In response to receipt of a request packet from the seller's computer terminal 10 containing a seller's order as indicated in FIG. 2 (step 301), the processor 42 proceeds to step 302 to advertise the contents of the order on the Web server 43. Flow proceeds to step 303 to check to see if a buyer's order is received from the buyer's computer terminal 20. If no buyer's order is received at step 303, the processor 42 returns to step 301. As a result, if no buyer's order is received during a time a number of seller's orders are received, a plurality of bandwidth commodities are advertised on the electronic bulletin board 43, as illustrated in FIG. 4.

One example of a number of advertised sellers' orders is illustrated in FIG. 4. Each seller's order includes a plurality of terms which a seller and a buyer are bound to observe when a contract is established. Details of FIG. 4 will be described later.

Prospect buyers access the Web server 43 to browse the advertised seller's orders. If a seller's order satisfies the needs of a buyer, a buyer's order containing the commodity ID of the seller's order is transmitted from the buyer's terminal to the trading point 40.

If a buyer's order is received at step 303, flow proceeds to step 304 to examine the bulletin board 43 to check to see if a corresponding seller's order is available. If not, flow proceeds to step 309 to send a reject message to the buyer terminal. If a seller's order corresponding to the buyer's order is available, flow proceeds from step 304 to step 305 to verify the buyer's terminal. If the buyer's terminal is not authorized terminal, a reject message is returned to the buyer's terminal (step 309). If the buyer's terminal is verified, it is determined that a contract can be concluded between the seller's terminal and the buyer's terminal and flow proceeds to step 306 to transmit the terms of the contract to the buyer's terminal. At step 307, the contracted terms are stored in the database 44 and the contracted seller's order is deleted from the bulletin board 43 (step 308).

In order to give buyers flexibility in using contracted bandwidth segment, each term of contract has a range of selectable items or values or has only one predetermined item or value. In FIG. 2, the terms indicated in thick solid rectangles contain selectable items or values. In this case, the buyer has the right to select one of the selectable items or values. The terms indicated in thin solid rectangles contain non-selectable item or value. In this case, the buyers have no right to select other than the specified item or value. For example, the commodity ID 12345, the seller specifies that 45 Mbps is the maximum transmission speed, allowing the buyer to select a desired speed value equal to or lower than the maximum speed. In the commodity ID 13579, a set speed of 155 Mbps is specified, not allowing the buyer to select other than the specified value. The seller of ID 12345 further specifies the Tokyo Metropolitan area as a selectable range of connecting points for a first connecting point of the bandwidth segment and Osaka pooling point as a second connecting point. In this case, the buyer is allowed to select any telephone switching office within the Tokyo Metropolitan area as a first connecting point. The seller may specify in the time-to-start using term an indication that the buyer is allowed to start using the commodity anytime one week after purchase. Class-1 and class-2 are indicated in the quality of service item. The buyer is allowed to select one of the two classes.

Two connecting points are always associated with a bandwidth segment. The connecting point may be a pooling point of commoditized bandwidth segments and the number of pooling points pooled varies depending on the type of communication. In the case of internet access, one of the connecting points is a pooling point (Yokohama pooling point) and the other is an Internet Service Provider as indicated in the seller's order ID 67890. In the case of point-to-point communication, two pooling points are specified. In the case of a point-to-multipoint communication such as multicast mode of communication, the seller specifies more than two connecting points as illustrated in the commodity ID 13579. Quality-of-service can also be specified by such parameters as delays, down-time during protection switching, and the number of hops. The seller can specify in the local-loop protocol field of the bulletin board a single mode of transmission or a plurality of selectable transmission modes.

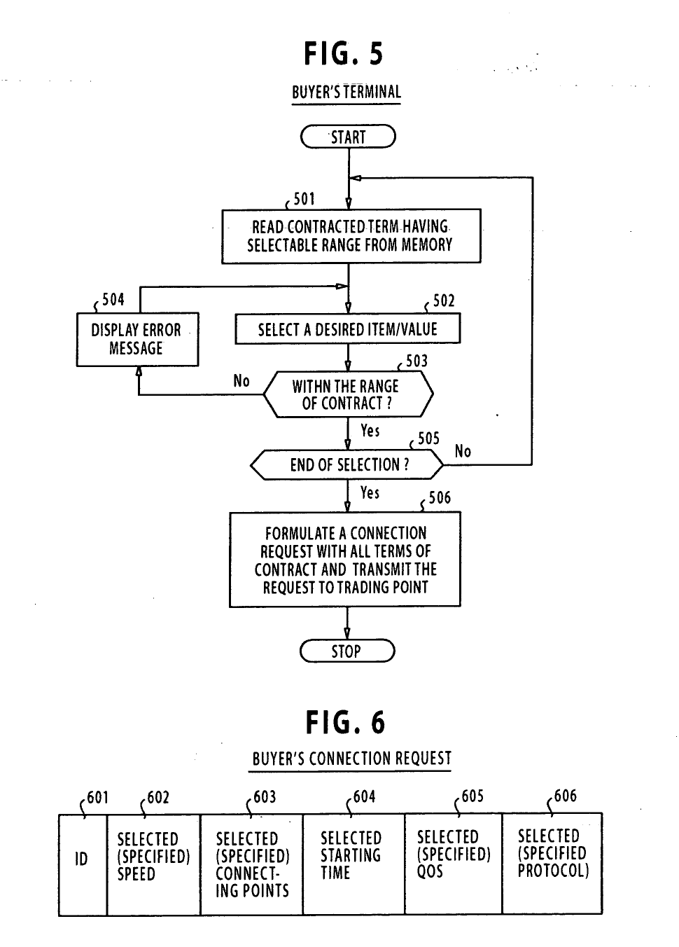

When the buyer's computer terminal 20 receives the terms of the contract from the trading point system 40, it stores the received data in a memory. When the actual use of the contracted bandwidth segment is contemplated, the buyer's terminal 20 operates according to the flowchart of FIG. 5. At step 501, the buyer's terminal 20 reads a selectable term from the memory and puts it on display. In response to an entered manual selection command, the computer terminal 20 selects a desired item or value from the selectable term at step 502 and checks to see if the selected item or value is within the range of contract. If not, flow proceeds to step 504 to display an error message and returns to step 502 to repeat the selection. If the decision is affirmative at check step 503, flow proceeds to step 505 to determine if all selectable terms are read from the memory. If not, flow returns to step 501 to read the next selectable term from the memory.

At the end of selection, flow proceeds to step 506 to formulate a connection request with all terms of contract and transmits the connection request to the trading point system 40.

As shown in FIG. 6, the connection request contains a plurality of terms 601 through 606 for indicating the commodity ID (601), a selected or specified connecting points (603), a selected starting date (604), a selected or specified QOS (605) and a selected or specified local-loop protocol (606).

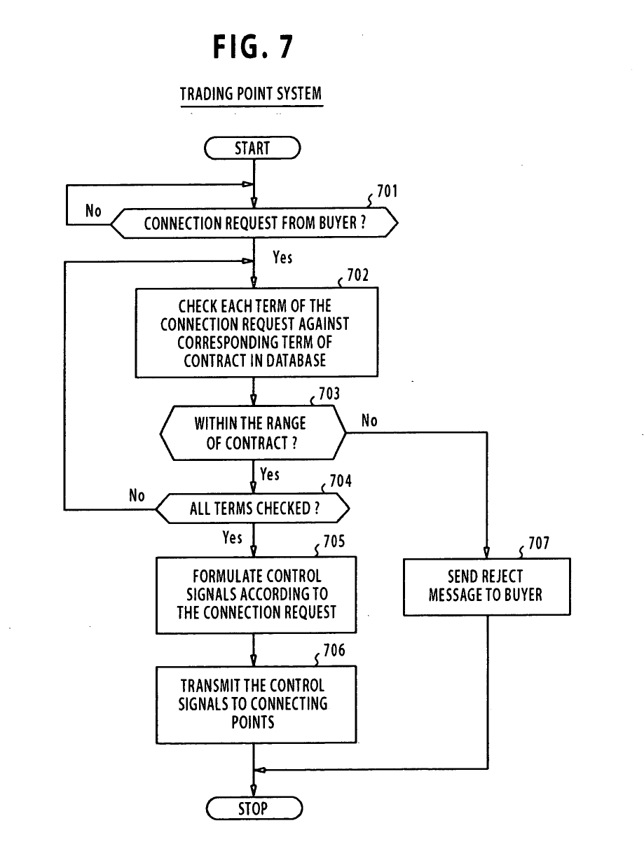

In FIG. 7, the trading point processor 42 responds to the connection request form the buyer's terminal 20 (step 701) by checking the selected item or value of each term of the contract with the corresponding term of contract stored in the database 44 (step 702) and determines whether the selected item or value is within the range of contract (step 703). If the selected item or value is outside of the range of contract, it is determined that the buyer is violating the contract and the trading point processor transmits a reject message to the buyer's terminal (step 707). If the buyer is not violating the contract, flow proceeds from step 703 to step 704 to check to see if all selectable terms are checked. If not, flow returns to step 702 to repeat the process. If all terms are selected, flow proceeds to step 705 to formulate control signals according to the received connection request and transmits the control signals to the connecting points, respectively (step 706). Therefore, the connecting point 51 establishes a connection between one end of a bandwidth segment 50 specified by the connection request and the buyer's network 60 and the connecting point 52 establishes a connection between the other end of the bandwidth segment 50 and the buyer's network 61.

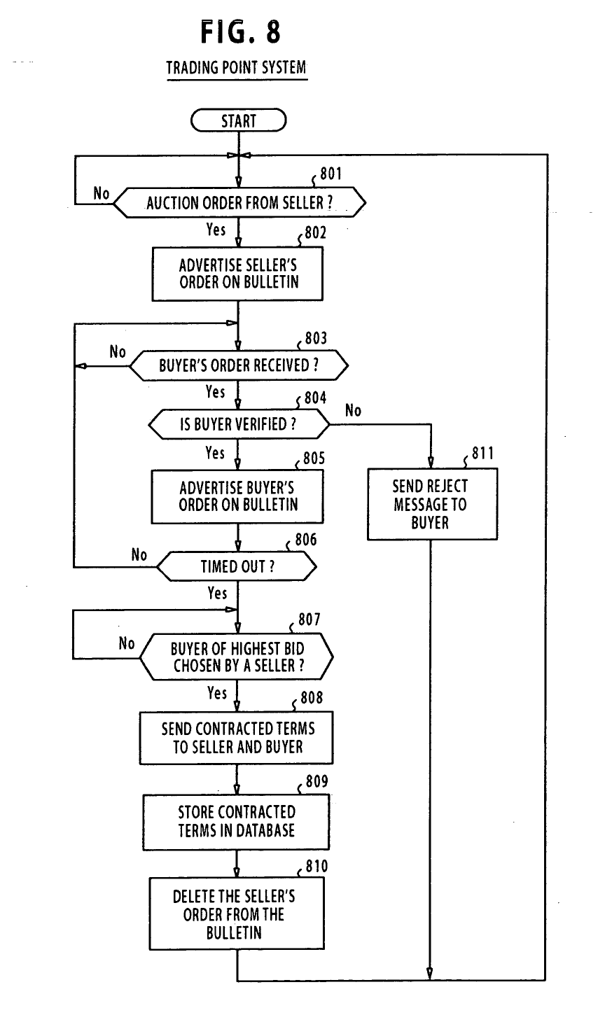

FIG. 8 is a flowchart of the operation of the trading point processor in an auction mode according to a second embodiment of the present invention.

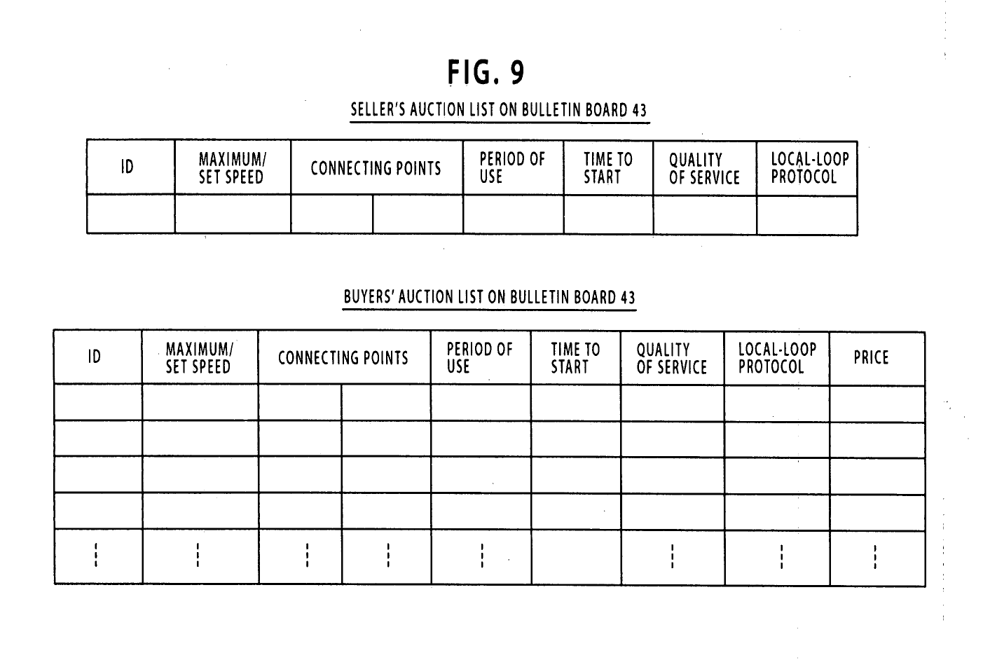

In an auction mode, the seller's computer terminal 10 transmits an auction order, which the trading point processor receives at step 801. At step 802, the processor advertises the seller's auction order on the Web server 43 as shown in FIG. 9, and proceeds to step 803 to check to see if a buyer's order (bid) is received. In this case, no price is indicated in the seller's auction order. If a buyer's order is received, flow proceeds from step 803 to step 804 to check to see if the buyer's terminal is an authorized terminal. If the buyer's terminal is not verified, a reject message is sent to the buyer's terminal (step 811). If the buyer is verified, flow proceeds from step 804 to step 805 to advertise the buyer's order on the Web server 43. Flow proceeds to step 806 to check to see if a predefined time-out period has expired. If not, flow returns to step 803.

As a result, if a number of buyers responded to the seller's auction order within the time-out period, their bids (containing their price) are advertised on the Web server 43 as shown in FIG. 9. Then, the seller chooses a buyer whose bid is highest of all and transmits a signal to the trading point 40, indicating the chosen buyer (step 807). At step 808, the processor 42 transmits contracted terms to the seller's terminal and the chosen buyer's terminal, stores the contracted terms in the database 44 (step 809), delete the seller's auction order from the bulletin board (step 810), and returns to the starting point of the routine.

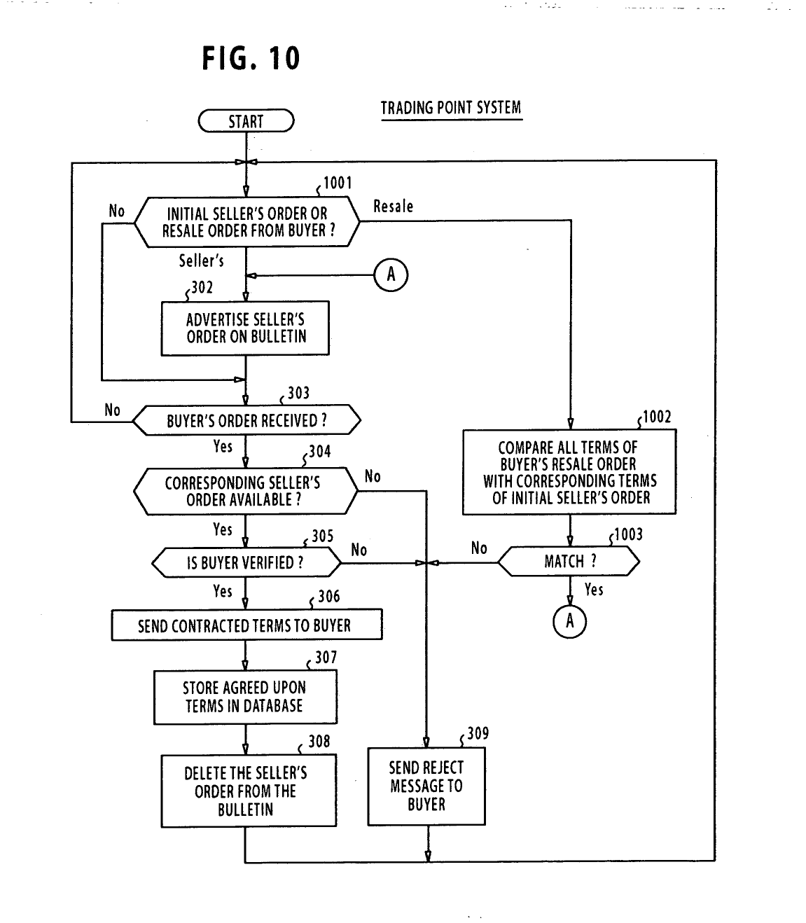

FIG. 10 is a flowchart of the operation of the trading point processor 42 when a resale order is received from a buyer. Such a resale order is transmitted from a buyer if a plan contemplated by the buyer is cancelled for some reason. In this case, the buyer has the right to put the commodity on resale. The flowchart of FIG. 10 is a modification of the flowchart of FIG. 3. Therefore, steps corresponding to those in FIG. 3 are marked with the same numerals as those used in FIG. 3 and the description thereof is omitted. When a usual seller's order is received at step 1001, flow proceeds to step 302 to advertise the received order on the bulletin board and proceeds to step 403 to check for the reception of a buyer's order. If no buyer's order is received, flow returns to step 1001 to repeat the process.

When a resale order is received from the buyer's terminal 20, flow proceeds from step 1001 to step 1002 to compare all terms of the buyer's resale order with corresponding terms of the initial seller's order for a match or mismatch (step 1003). If they match, flow proceeds from step 1003 to step 302 to advertise the reseller's order on the bulletin board. If they mismatch, flow proceeds to step 309 to transmit a reject message to the reseller's (buyer's) terminal.

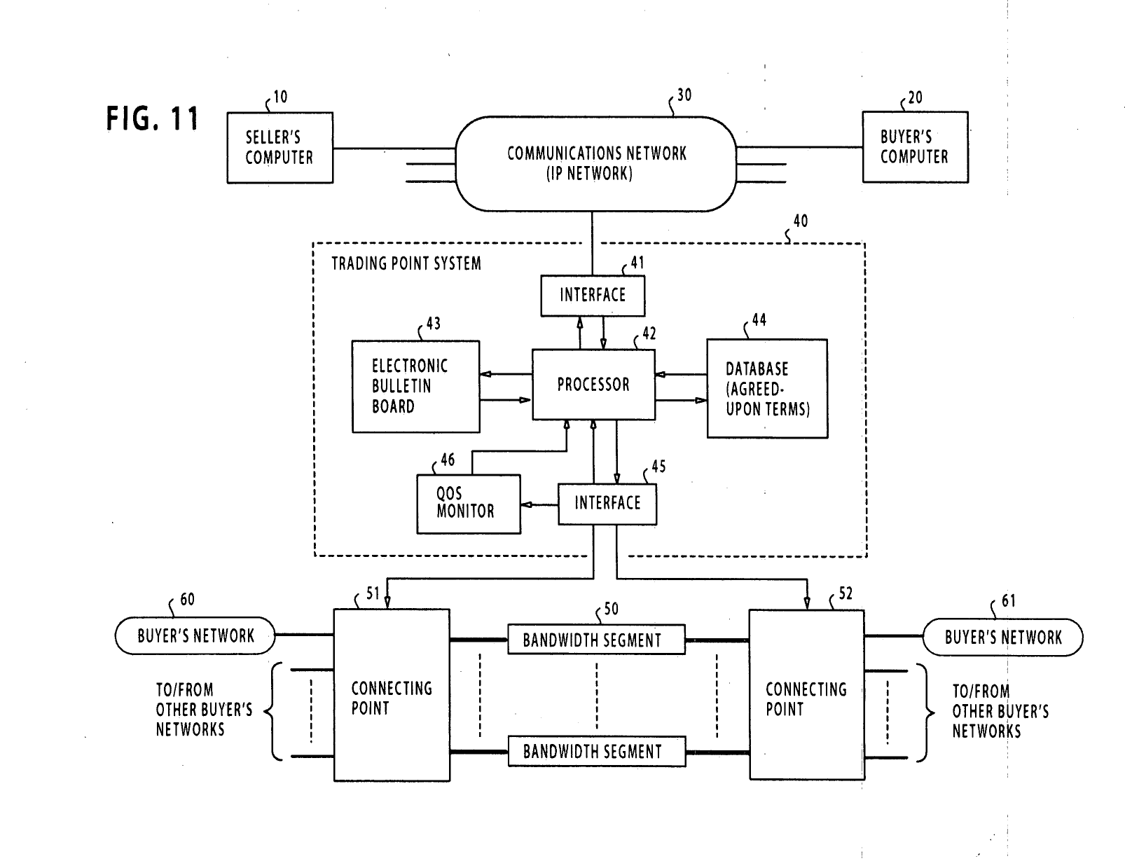

As shown in FIG. 11, the trading point system 40 additionally includes a QOS monitor 46 that is connected to the line interface 45 and the processor 42. QOS monitor 46 monitors the quality of the contracted bandwidth segment currently used in the buyer's networks 60, 61 at periodic intervals. A contract is concluded according to a service level agreement between the seller and the buyer regarding the monitoring interval well in advance of the actual use and stored in the database 44. Preferably, the quality of signal is evaluated according to the American National Standard for Telecommunications (Digital Hierarchy-Layer 1 In-Service Digital Transmission Performance Monitoring). Specifically, the parameter “Errored Second” is useful for monitoring bandwidth segments.

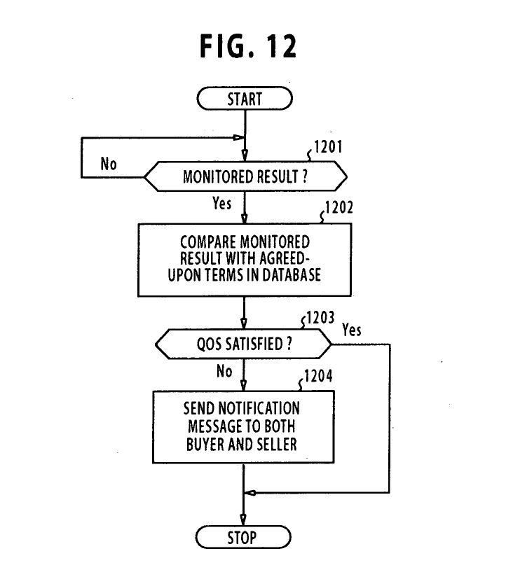

As illustrated in FIG. 12, when the QOS monitor determines the quality of the bandwidth segment it provides the processor 42 with a monitored result (step 1201). Processor 42 compares the monitored result with agreed-upon terms stored in the database 44, concerning the performance of contracted bandwidth segment. If the monitored result fails to satisfy the agreed-upon QOS value (step 1203), flow proceeds to step 1204 to transmit a notification message to both the seller's terminal 10 and the buyer's terminal 20. If errored seconds occur at a rate higher than the agreed-upon rate, the notification message indicates that the contract is violated.

1. A commoditized bandwidth trading system comprising:
a seller's terminal for transmitting a seller's order indicating a plurality of bandwidth contract terms, at least one of said bandwidth contract terms containing a selectable range of characteristics;
a trading point for receiving the seller's order and advertising said plurality of bandwidth contract terms of the received seller's order and determining whether or not a buyer's response, which will be received in response to the advertised said seller's order, is verified;
a buyer's terminal for transmitting said buyer's response to said trading point in response to the advertised seller's order, selecting one of said characteristics of the advertised seller's order if said buyer's response is verified by said trading point, and transmitting a connection request indicating a plurality of bandwidth contract terms, at least one of the bandwidth contract terms containing said selected characteristic; and
connecting means for receiving said connection request from the buyer's terminal and connecting a bandwidth segment to a buyer's network according to said plurality of bandwidth contract terms indicated in the received connection request.

2. The commoditized bandwidth trading system of claim 1, wherein said buyer's terminal is configured to verify the selected characteristic by ensuring that the selected characteristic is within said selectable range.

3. The commoditized bandwidth trading system of claim 1, wherein said connecting means is configured to verify the selected characteristic contained in the received connection request by ensuring that the selected characteristic is within said selectable range.

4. The commoditized bandwidth trading system of claim 2, wherein said connecting means is configured to verify the selected characteristic contained in the received connection request by ensuring that the selected characteristic is within said selectable range.

5. The commoditized bandwidth trading system of claim 1, wherein said connecting means comprises said trading point and first and second connecting points,
wherein said trading point is configured to receive said connection request from the buyer's terminal, verify the received connection request, transform the received connection request to a first and a second control signal, and transmit the first and second control signals to said first and second connecting points, respectively,
wherein said first and second connecting points are configured to connect opposite ends of a pooled bandwidth segment to said buyer's network in response to said first and second control signals.

6. The commoditized bandwidth trading system of claim 1,
wherein said buyer's terminal is configured to transmit a buyer's bidding order as said buyer's response to said trading point when said seller's order is advertised by said trading point,
wherein said trading point is configured to determine whether or not the buyer's bidding order is verified and advertise buyer's bidding orders from a plurality of buyer's terminals if the buyer's bidding orders are verified,
wherein said seller's terminal is configured to choose one of said plurality of verified buyer's terminals whose advertised bid is highest of all advertised buyer's bidding orders, and
wherein said chosen buyer's terminal is configured to select one of the characteristics of the advertised seller's order.

7. The commoditized bandwidth trading system of claim 1,
wherein said buyer's terminal is configured to transmit a resale order to said trading point, indicating resale of a traded bandwidth segment, and
wherein said trading point is configured to compare the resale order and said seller's order for detecting a match or a mismatch and advertise the resale order if said match is detected.

8. The commoditized bandwidth trading system of claim 1, further comprising means for monitoring the quality of said connected bandwidth segment and transmitting a notification to said seller's terminal and said buyer's terminal if said monitored quality is lower than a contracted level.

9. The commoditized bandwidth trading system of claim 1, wherein said bandwidth contract terms include a range of selectable transmission speeds, an area of selectable connecting points, a range of selectable time to start using the bandwidth segment, a range of selectable communication protocol, and a range of selectable quality levels.

10. A method of trading a commoditized bandwidth, comprising the steps of:
a) transmitting a seller's order indicating a plurality of bandwidth contract terms from a seller's terminal to a trading point, at least one of said bandwidth contract terms containing a selectable range of characteristics;
b) receiving the seller's order at said trading point and advertising said plurality of bandwidth contract terms of the received seller's order;
c) transmitting a buyer's response from a buyer's terminal to said trading point in response to the advertised seller's order;
d) determining, at said trading point, whether or not said buyer's response is verified;
e) if said buyer's response is verified by said trading point, selecting one of said characteristics of the advertised seller's order at said buyer's terminal and transmitting a connection request indicating a plurality of bandwidth contract terms, at least one of the bandwidth contract terms containing said selected characteristic; and
f) responsive to said connection request from the buyer's terminal, connecting a bandwidth segment to a buyer's network according to said plurality of bandwidth contract terms indicated in said connection request.

11. The method of claim 10, wherein the step (e) comprises verifying the selected characteristic by ensuring that the selected characteristic is within said selectable range.

12. The method of claim 10, wherein the step (f) comprises verifying the selected characteristic contained in said connection request by ensuring that the selected characteristic is within said selectable range.

13. The method of claim 11, wherein the step (e) comprises verifying the selected characteristic contained in said connection request by ensuring that the selected characteristic is within said selectable range.

14. The method of claim 10, further comprising the step of repeating the steps (a) and (b) so that a plurality of seller's orders are advertised.

15. The method of claim 10, wherein the step (f) comprises the steps of:
receiving said connection request from the buyer's terminal;
verifying the received connection request;
transforming the received connection request to a first and a second control signal;
transmitting the first and second control signals to first and second connecting points, respectively;
connecting opposite ends of a pooled bandwidth segment to said buyer's network in response to said first and second control signals.

16. The method of claim 10, wherein the step (c) comprises the steps of:
transmitting a resale order from said buyer's terminal to said trading point, indicating resale of a traded bandwidth segment;
comparing, at said trading point, the resale order and said seller's order for detecting a match or a mismatch; and
advertising the resale order if said match is detected.

17. The method of claim 10, further comprising the steps of:
monitoring the quality of said connected bandwidth segment;
comparing the monitored quality with a contracted level; and
transmitting a notification to said seller's terminal and said buyer's terminal if said monitored quality is lower than said contracted level.

18. The method of claim 10, wherein said bandwidth contract terms include a range of selectable transmission speeds, an area of selectable connecting points, a range of selectable time to start using the bandwidth segment, a range of selectable communication protocol, and a range of selectable quality levels.

19. A method of trading a commoditized bandwidth, comprising the steps of:
a) transmitting a seller's auction order indicating a plurality of bandwidth contract terms from a seller's terminal to a trading point, at least one of said bandwidth contract terms containing a selectable range of characteristics;
b) receiving the seller's order at said trading point and advertising said plurality of bandwidth contract terms of the received seller's auction order;
c) transmitting a buyer's bidding order from a buyer's terminal to said trading point in response to the advertised seller's order;
d) determining, at said trading point, whether or not said buyer's bidding order is verified, and advertising the buyer's bidding order if said buyer's bidding order is verified;
e) repeating the steps (b) to (d) so that a plurality of verified buyer's bidding orders are advertised;
f) choosing, at said seller's terminal, one of said plurality of buyer's terminals whose advertised bid is highest of all advertised buyer's bidding orders;
g) selecting one of said characteristics of the advertised seller's order at said chosen buyer's terminal and transmitting a connection request indicating a plurality of bandwidth contract terms, at least one of the bandwidth contract terms containing said selected characteristic; and
h) responsive to said connection request from the chosen buyer's terminal, connecting a bandwidth segment to a buyer's network according to said plurality of bandwidth contract terms indicated in said connection request.

20. A storage medium containing a computer-executable program of trading a commoditized bandwidth, said program comprising the steps of:
a) transmitting a seller's order indicating a plurality of bandwidth contract terms from a seller's terminal to a trading point, at least one of said bandwidth contract terms containing a selectable range of characteristics;
b) receiving the seller's order at said trading point and advertising said plurality of bandwidth contract terms of the received seller's order;
c) transmitting a buyer's response from a buyer's terminal to said trading point in response to the advertised seller's order;
d) determining, at said trading point, whether or not said buyer's response is verified;
e) if said buyer's response is verified by said trading point, selecting one of said characteristics of the advertised seller's order at said buyer's terminal and transmitting a connection request indicating a plurality of bandwidth contract terms, at least one of the bandwidth contract terms containing said selected characteristic; and
f) responsive to said connection request from the buyer's terminal, connecting a bandwidth segment to a buyer's network according to said plurality of bandwidth contract terms indicated in said connection request.

21. The storage medium of claim 20, wherein the step (d) comprises verifying the selected characteristic by ensuring that the selected characteristic is within said selectable range.

22. The storage medium of claim 20, wherein the step (e) comprises verifying the selected characteristic contained in said connection request by ensuring that the selected characteristic is within said selectable range.

23. The storage medium of claim 21, wherein the step (e) comprises verifying the selected characteristic contained in said connection request by ensuring that the selected characteristic is within said selectable range.

24. The storage medium of claim 20, further comprising the step of repeating the steps (a) and (b) so that a plurality of seller's orders are advertised.

25. The storage medium of claim 20, wherein the step (f) comprises the steps of:
receiving said connection request from the buyer's terminal;
verifying the received connection request;
transforming the received connection request to a first and a second control signal;
transmitting the first and second control signals to first and second connecting points, respectively;
connecting opposite ends of a pooled bandwidth segment to said buyer's network in response to said first and second control signals.

26. The storage medium of claim 20, wherein the step (c) comprises the steps of:
transmitting a resale order from said buyer's terminal to said seller's terminal via said trading point, indicating resale of a traded bandwidth segment;
comparing, at said trading point, the resale order and said seller's order for detecting a match or a mismatch; and
advertising the resale order if said match is detected.

27. The storage medium of claim 20, further comprising the steps of:
monitoring the quality of said connected bandwidth segment;
comparing the monitored quality with a contracted level; and
transmitting a notification to said seller's terminal and said buyer's terminal if said monitored quality is lower than said contracted level.

28. The storage medium of claim 20, wherein said bandwidth contract terms include a range of selectable transmission speeds, an area of selectable connecting points, a range of selectable time to start using the bandwidth segment, a range of selectable communication protocol, and a range of selectable quality levels.

29. A storage medium containing a computer-executable program of trading a commoditized bandwidth, said program comprising the steps of:
a) transmitting a seller's auction order indicating a plurality of bandwidth contract terms from a seller's terminal to a trading point, at least one of said bandwidth contract terms containing a selectable range of characteristics;
b) receiving the seller's order at said trading point and advertising said plurality of bandwidth contract terms of the received seller's auction order;
c) transmitting a buyer's bidding order from a buyer's terminal to said trading point in response to the advertised seller's order;
d) determining, at said trading point, whether or not said buyer's bidding order is verified, and advertising the buyer's bidding order if said buyer's bidding order is verified;
e) repeating the steps (b) to (d) so that a plurality of verified buyer's bidding orders are advertised;
f) choosing, at said seller's terminal, one of said plurality of buyer's terminals whose advertised bid is highest of all advertised buyer's bidding orders;
g) selecting one of said characteristics of the advertised seller's order at said chosen buyer's terminal and transmitting a connection request indicating a plurality of bandwidth contract terms, at least one of the bandwidth contract terms containing said selected characteristic; and
h) responsive to said connection request from the chosen buyer's terminal, connecting a bandwidth segment to a buyer's network according to said plurality of bandwidth contract terms indicated in said connection request.
